(19) United States
(12) Patent Application Publication
(10) Pub. No.: US 2018/0269480 A1
(43) Pub. Date: Sep. 20, 2018

(54) SILICON-CARBON NANOSTRUCTURED COMPOSITES

(71) Applicant: AXIUM IP, LLC, Los Angeles, CA (US)

(72) Inventors: Kyoung KIM, Austin, TX (US); Daehwan CHO, Seoul (KR)

(73) Assignee: AXIUM IP, LLC, Los Angeles, CA (US)

(21) Appl. No.: 15/547,616

(22) PCT Filed: Feb. 4, 2016
(86) PCT No.: PCT/US2016/016609

§ 371 Date: Jul. 31, 2017

Related U.S. Application Data
(60) Provisional application No. 62/111,908, filed on Feb. 4, 2015.
(60) Provisional application No. 62/247,157, filed on Oct. 27, 2015.

(51) Int. Cl. H01M 4/587; C01B 32/05; C01B 33/025; H01M 10/0525; H01M 4/133; H01M 4/134; H01M 4/36; H01M 4/38

(52) U.S. Cl. CPC H01M 4/587; C01B 32/05; C01B 33/025; H01M 10/0525; H01M 2004/027; H01M 4/134; H01M 4/364; H01M 4/386; H01M 4/133

(57) ABSTRACT

Provided herein are silicon-carbon nanostructured composites, precursors thereof, and processes for manufacturing such materials. Also provided herein are applications of such silicon-carbon composites, including uses in lithium ion batteries and anodes thereof.

### CROSS-REFERENCE

This application claims the benefit of U.S. Provisional Application Nos. 62/111,908, filed Feb. 4, 2015, and 62/247,157, filed Oct. 27, 2015, both of which are incorporated herein by reference in their entireties.

### BACKGROUND OF THE INVENTION

Batteries comprise one or more electrochemical cell, such cells generally comprising a cathode, an anode and an electrolyte. Lithium ion batteries are high energy density batteries that are fairly commonly used in consumer electronics and electric vehicles. In lithium ion batteries, lithium ions generally move from the negative electrode to the positive electrode during discharge and vice versa when charging. In the as-fabricated and discharged state, lithium ion batteries often comprise a lithium compound (such as a lithium metal oxide) at the cathode (positive electrode) and another material, generally carbon, at the anode (negative electrode).

### SUMMARY OF THE INVENTION

Provided in certain embodiments herein are nanostructured silicon-carbon composites, precursors thereof, and manufacturing thereof. In specific embodiments, provided herein is a process of electrospinning a composition comprising a polymer and a silicon precursor component, and thermally treating the resultant material (e.g., to anneal the polymer, carbonize the polymer, and/or convert the silicon precursor component—or at least a portion thereof—to a silicon material, such as an electrode active (e.g., as a negative electrode in a lithium ion battery) silicon material (e.g., elemental silicon, substoichiometric silica, or other active silicon ceramic). In specific embodiments, the silicon material is or comprises any suitable material, such as SiOₐN_{b}C_{c} (e.g., wherein 0≤a≤2, 0≤b≤4/3, and 0≤c≤1, and, e.g., wherein a/2+3b/4+c is about 1 or less), such as amorphous silicon, crystalline silicon, sub-stoichiometric silica SiOx (e.g., wherein 0<x<2), silicon carbide, silicon nitride, and/or combinations thereof. In specific embodiments, provided herein are nanostructured silicon-carbon composites comprising carbon and a silicon material (e.g., amorphous silicon).

In some instances, use of preformed crystalline silicon nanostructures in nanostructured carbon-silicon composites alone results in less than optimal performance (e.g., cycling) parameters. In certain instances, preformed crystalline silicon particles have highly ordered structures and tend to agglomerate/aggregate, resulting in large rigid silicon bodies with less than optimal pulverization tendencies. In some embodiments, nanostructures provided herein comprises silicon material. In specific embodiments, at least a portion of the silicon material is amorphous SiOx (e.g., wherein (0≤x<2, such as x=0). In certain instances, in situ formation of nanostructured silicon material (e.g., according to the processes described herein) decreases silicon agglomeration possibilities (e.g., due to its embedding in a nanostructured matrix, which blocks agglomeration) and/or provides formation of amorphous silicon content. In some instances, use of electrodes (e.g., anodes) comprising such composite materials in lithium batteries (e.g., lithium ion batteries) results in improved performance (e.g., cycling) characteristics and/or reduced silicon pulverization over materials using preformed crystalline structures silicon alone.

In specific embodiments provided herein is a process for preparing a nanostructured silicon-carbon composite, the process comprising:
a. combining (i) a polymer, (ii) a silicon precursor, and (iii) a liquid medium to form a fluid composition;
b. electrospinning the fluid composition to form a nanostructured polymer composite; and
c. thermally treating the nanostructured polymer composite.

Any suitable polymer is optionally utilized, such as is polyacrylonitrile (PAN), polyvinyl ether (PVE), polyethylene oxide (PEO), polyvinyl alcohol (PVA), polyvinylpyrrolidone (PVP), poly acrylic acid (PAA), or a combination thereof. Any suitable silicon precursor or silicon precursor component is optionally utilized, such as a silicon containing compound that can be thermally or thermoreductively converted to a silicon material (e.g., an electrode active silicon material, such as having the formula SiOₐN_{b}C_{c}, described herein). In specific embodiments, the silicon precursor or silicon precursor component is an organosilicon, a silicon halide, a sol gel precursor of a silicon ceramic, a siloxane, a silsesquioxane, a silazane, an organosilicate, or a combination thereof. In specific embodiments, the silicon precursor is silicon chloride, tetraethyl orthosilicate (TEOS) or silicon acetate. In various embodiments, any suitable amount of polymer and silicon precursor component is optionally utilized. In some embodiments, the weight ratio of polymer to silicon precursor is 2:3 to 10:1 (e.g., 5:4 to 5:1).

In certain embodiments, preformed crystalline nanostructures are optionally included. In some embodiments, formation of the fluid composition comprises combining (i) a polymer, (ii) a silicon precursor, (iii) a liquid medium, and (iv) nanostructures comprising silicon (e.g., any suitable silicon material that is an electrode active material, particularly as a negative electrode in a lithium ion cell). Any suitable amount of preformed silicon nanostructures are optionally included. In specific embodiments, the weight ratio of polymer to silicon nanostructures (e.g., nanostructured inclusions comprising a silicon material, described herein, such as silicon) is 2:3 to 10:1 (e.g., 5:4 to 5:1). In further or alternative specific embodiments, the weight ratio of silicon precursor to silicon nanostructure is greater than 1:1.

In some embodiments, preformed conducting nanostructures are optionally included. In certain embodiments, formation of the fluid composition comprises combining (i) a polymer, (ii) a silicon precursor, (iii) a liquid medium, (iv) nanostructures comprising a silicon material (e.g., silicon, SiOx, and/or SiOₐN_{b}C_{c}), and (v) conducting (e.g., electronic and/or electrically conducting) nanostructures. In specific embodiments, the conducting nanostructures are conducting carbon nanostructures, conducting metal nanostructures, or conducting metal oxide nanostructures. In specific embodiments, the conducting nanostructures are carbon nanostructures, such as carbon nanotubes (CNTs), graphene nanoribbons (GNRs), or a combination thereof. In alternative embodiments, the conducting nanostructures comprise a conducting metal or metal oxide (e.g., TiO₂ or Al₂O₃). Any suitable amount of conducting material is optionally utilized. In specific embodiments, the weight ratio of the polymer to the conducting nanostructures is 1000:1 to 10:1.

In various embodiments, the fluid medium is any fluid/solvent suitable for electrospinning. In some embodiments, a fluid medium is optional absent if a polymer melt is instead utilized. In some embodiments, the liquid medium is dimethyl formamide (DMF), water, dimethylacetamide (DMAC), chloroform, alcohol, tetrahydrofuran (THF), or a combination thereof. In various embodiments, any suitable amount of liquid medium is utilized (in other words, any suitable concentration of components are combined with the liquid medium). In specific embodiments, the polymer is combined in a wt/wt concentration of 2-30% (e.g., 5-15%), relative to the liquid medium (and, for example, other component parts are added in an amount described herein relative to the polymer component). Generally, any suitable electrospinning processes is optionally utilized herein, but gas-assisted electrospinning is preferred in some embodiments for providing high throughput manufacturing and good dispersion of the component parts in the precursor polymer composite and ultimate silicon-carbon composite materials.

In specific embodiments, the thermal treatment comprises an optional annealing step, a carbonization step, and a silicon precursor component to silicon conversion step—the carbonization and silicon conversion step optionally being performed concurrently. In some embodiments, thermal treatment of the nanostructured composite comprises a step of heating to at least 500 C (e.g., at least 800 C, 800 C to 1400 C, or 1100 C to 1400 C) (e.g., to carbonize the polymer and/or at least partially thermoreduce the silicon precursor component to silicon, such as amorphous silicon). In specific embodiments, thermal treatment of the nanostructured polymer comprises at least one heating step that is performed under an atmosphere comprising hydrogen. In specific embodiments, the atmosphere comprises at least 2% hydrogen (e.g., in combination with an inert gas, such as nitrogen or argon). In some embodiments, the process or the thermal treatment step further comprises annealing the nanostructured polymer composite (e.g., prior to polymer carbonization and/or conversion of silicon precursor component) (e.g., at a temperature of 100 C to 500 C).

In specific embodiments, the process described herein is used for preparing a battery electrode active material (e.g., wherein the silicon-carbon composite material is the electrode active material). In some embodiments, the process further comprises assembling a battery cell comprising the nanostructured silicon-carbon composite. In specific embodiments, the electrode is an anode and the battery is a lithium ion battery.

Also provided herein are fluid compositions, polymer composites and silicon-carbon composites prepared according to any process herein, or comprising the component parts (e.g., in the amounts described herein).

In specific embodiments, provided herein are silicon-carbon carbon nanofibers comprising a carbon matrix with domains (e.g., nanosized domains) embedded therein, the domains comprising silicon (amorphous silicon). In certain specific embodiments, certain domains within the carbon matrix comprise amorphous silicon and other domains comprise crystalline silicon. In some embodiments, provided herein is a silicon-carbon nanocomposite nanofiber comprising (i) a matrix comprising carbon and amorphous silicon, and (ii) crystalline domains of silicon (e.g., silicon nanoparticles) embedded in the matrix. In some embodiments, provided herein is a silicon-carbon composite nanofiber comprising carbon and a reduced silicon ceramic (e.g., partially reduced, such as to SiOx (e.g., 0<x<2) or SiOₐN_{b}C_{c} (wherein a, b, and c are as described herein), or fully reduced to Si). Also provided in specific embodiments herein is a composite nanofiber comprising (i) a matrix comprising polymer and a silicon oxide (e.g., SiOx, wherein 0<x<2), and (ii) crystalline domains of silicon (e.g., silicon nanoparticles) embedded in the matrix (e.g., a precursor material to the silicon-carbon composites described herein).

### BRIEF DESCRIPTION OF THE DRAWINGS

The novel features of the invention are set forth with particularity in the appended claims. A better understanding of the features and advantages of the present invention will be obtained by reference to the following detailed description that sets forth illustrative embodiments, in which the principles of the invention are utilized, and the accompanying drawings of which:

FIG. 1 illustrates an exemplary silazane macrostructure, which is optionally used as a silicon precursor herein.

FIG. 2 illustrates an exemplary silsesquioxane cage macrostructure, which is optionally used as a silicon precursor herein.

FIG. 3 illustrates an exemplary silsesquioxane open cage macrostructure, which is optionally used as a silicon precursor herein.

FIG. 4 illustrates an exemplary electrospinning nozzle system for preparing nanostructured precursors materials provided herein.

FIG. 5 illustrates exemplary lithium ion battery anode capacities and cycling of anodes comprising exemplary nanostructured composites provided herein.

FIG. 6 illustrates exemplary lithium ion battery anode capacities and cycling of anodes comprising exemplary composites, including silicon nanoparticles and CNT inclusions, provided herein.

FIG. 7 illustrates X-Ray diffraction (XRD) traces of various composites provided herein.

### DETAILED DESCRIPTION OF THE INVENTION

Generally, small silicon particles are difficult to manufacture and, once manufactured, are difficult to keep from agglomerating to form larger particles. Further, reduction of silica nanoparticles and other bulk silicon ceramic materials are extremely difficult to achieve, especially on a commercial scale. Provided in some instances herein are nanostructured silicon materials, as well as processes for manufacturing such nanostructured silicon materials. These nanostructured silicon materials are useful in a number of applications, including in lithium ion battery anode materials.

Provided herein are silicon-carbon composite nanomaterials, as well as methods of manufacturing such silicon-carbon composite nanomaterials and uses of such silicon-carbon composite nanomaterials, particularly lithium ion batteries comprising such silicon-carbon composite nanomaterials as an active anode material. In addition, provided herein are precursor materials and compositions of such silicon-carbon composite nanomaterials.

In certain embodiments, provided herein is a process for preparing a nanostructured silicon-carbon composite, the process comprising electrospinning a fluid stock comprising a polymer and a silicon precursor component to produce a nanomaterial (e.g., nanofiber), and thermally treating the nanomaterial. In specific embodiments, the thermal treatment (at least partially) thermally reduces the silicon precursor component and (at least partially) carbonizes the polymer component of the nanomaterial. In some instances, thermal reduction of the silicon precursor component and carbonization of the polymer component is achieved by thermally treating the nanomaterial under non-oxidative (e.g., inert or reductive) conditions. In some instances, the nanomaterial is optionally pretreated prior to thermal (e.g., thermoreductive) treatment, such as to thermally anneal or otherwise treat the nanomaterial prior to thermoreduction thereof (specifically, the silicon precursor component of the nanomaterial).

Silicon material provided in the silicon-carbon nanostructures provided herein comprises any suitable silicon material. In specific embodiments, the silicon material is a material that is active as an electrode material in a lithium battery (e.g., a lithium ion battery). In some embodiments, the silicon material is a material that is prepared or preparable by thermally treating (e.g., thermally reducing) a silicon precursor provided herein, or a cured or partially cured sol, sol-gel, or ceramic thereof. In specific embodiments, the silicon material comprises amorphous and/or crystalline domains. In specific embodiments, the silicon material comprises amorphous domains. In certain embodiments, the silicon material has the structure SiOₐN_{b}C_{c}. In some embodiments, 0≤a≤2, 0≤b≤4/3, and 0≤c≤1. In specific embodiments, a/2+3b/4+c is about 1 or less. In specific embodiments, the silicon material is a silicon oxide having the formula: SiOx (e.g., wherein 0<x<2; such as wherein a is x and b and c are 0) (such as a sub-stoichiometric silica). In other specific embodiments, the silicon material is silicon (e.g., elemental silicon, such as comprising amorphous domains thereof) (e.g., wherein a, b, and c are 0). In certain embodiments, the silicon oxide further comprises silicon nitride and/or silicon carbide moieties (e.g., wherein b and/or c are greater than 0).

In certain embodiments, provided herein is a process for preparing a nanostructured silicon-carbon composite, the process comprising:
a. electrospinning a fluid composition to form a nanomaterial (e.g., a nanostructured polymer composite), the fluid composition comprising a polymer component and a silicon precursor component; and
b. thermally treating the nanomaterial.

In further or alternative embodiments, provided herein is a process for preparing a nanostructured silicon-carbon composite, the process comprising:
a. combining (i) a polymer, (ii) a silicon precursor, and (iii) a liquid medium to form a fluid composition;
b. electrospinning the fluid composition to form a nanomaterial; and
c. thermally treating the nanomaterial.

In specific embodiments, the silicon precursor component or silicon precursor is a non-elemental silicon, such as an organosilicon, a silicon halide, a siloxane, a silsesquioxane, a silazane (e.g., perhydropolysilazane or an organopolysilazane), an organosilicate, or the like. In further embodiments, the silicon precursor component is optionally a sol gel (silicon containing) ceramic precursor (which may be partially cured), such as a sol gel prepared from tetraethyl orthosilicate (TEOS), silicon acetate, or the like.

In certain embodiments, the silicon precursor component or silicon precursor comprises a structural (e.g., repeat) unit represented by the general formula:

—[SiR¹R²—X]— (I)

In certain embodiments, X is absent (e.g., forming a bond), O, or NR³. In some embodiments, each R¹, R² and R³ are each independently a hydrogen, a halide, OR⁴, NR⁴₂, SiR⁴₃, OSiR⁴₃, or a substituted or unsubstituted hydrocarbon (e.g., alkyl). In some instances, each R³ is independently hydrogen, SiR⁴₃, or a substituted or unsubstituted hydrocarbon. In certain embodiments, each R⁴ is independently hydrogen, a negative charge (e.g., optionally when attached to O or S), or a substituted or unsubstituted hydrocarbon. In some instances, R¹ and R² are taken together to form an oxo (═O). In various embodiments, the hydrocarbon is optionally substituted with halo (e.g., chloride, bromide and/or fluoride), hydroxyl, epoxide, oxo, epoxy, alkoxy, alkoxycarbonyl, a silyl (e.g., an alkylsilyl, a halosilyl, or the like), silicate (e.g., alkylsilicate), amino (e.g., NH₂, or alkylamino), or a combination thereof. In further embodiments, R¹, R², R³, and R⁴ is optionally, or a hydrocarbon thereof is optionally substituted with, a silicon containing group such as, for example, siloxyl, organosiloxyl, silsesquioxyl, organosilsesquioxyl, silyl, an organosilyl (e.g., alkylsilyl), a halosilyl, a silicate (e.g., alkylsilicate), or the like. Examples of hydrocarbons include, by way of non limiting example, an alkyl group (e.g., branched or unbranched and saturated (saturated alkyl groups including alkenyl groups having at least one C═C bond and alkynyl groups) or unsaturated), a cycloalkyl group (saturated or unsaturated), a cycloalkylalkyl group, an aryl group, and an arylalkyl group. The number of carbon atoms in these hydrocarbon atoms is not limited, but is optionally 20 or less, and preferably 10 or less. In some instances, the hydrocarbon is an alkyl group having 1 to 8 carbon atoms, and particularly 1 to 4 carbon atoms. In some instances, the hydrocarbon group is substituted with a silyl group, e.g., is an alkyl group having 1 to 20 carbon atoms, and particularly 1 to 6 carbon atoms or 1 to 3 carbon atoms. In specific instances, the substituted hydrocarbon is an aminoalkyl amino group, e.g., having 1 to 6 or 1 to 3 carbon atoms. In certain embodiments, any one or more carbon of the hydrocarbon is optionally substituted (replaced) with an oxygen (e.g., CH₂ replaced with O) or nitrogen (e.g., CH₂ replaced with NH) (e.g., forming a heteroalkyl (e.g., polyethylene glycol (PEG)), heterocycl, heteroaryl, or the like). In certain embodiments, any organo compound described herein is a compound substituted with any one or more hydrocarbon described herein. In certain embodiments, each end of the unit is either attached to another unit or terminates in a hydrogen, a halide, OR⁴, SR⁴, SiR⁴₃, OSiR⁴₃, or a substituted or unsubstituted hydrocarbon. In some embodiments, a silicon precursor or silicon precursor component provided herein comprises a plurality (n) units of formula I (e.g., wherein n is 2 and 10,000) and wherein each R¹, R², and X of each unit is independently selected from the groups listed above.

In some instances, the silicon precursor component or silicon precursor comprises multiple units of general formula (I), e.g., in a chain, a ring, a cage, a cross-linked structure, or a combination thereof. In some instances, a plurality of units are attached adjacent to each other in a chain, such as represented by formula (Ia):

—[SiR¹R²—X]—[SiR¹R²—X]— (Ia)

In some instances, such as wherein the compound comprises ring, cage, and/or cross-linked structures, the R¹, R², or R³ of a first unit of formula (I) is optionally taken together with the R¹, R², or R³ of another (e.g., adjacent, or 3-15 units away or more such as in the case of a ring or cage, or a separate chain, ring or cage in the case of cross-linked structures) unit, such as to form, when taken together, a bond, —O—, a silyl (e.g., hydrosilyl or organosilyl) or a substituted or unsubstituted hydrocarbon. In specific instances, an R¹ group and an R³ group (e.g., wherein X is NR³) of different units are optionally taken together to form a bond. In further or alternative specific embodiments, two R¹ groups (e.g., each of a different unit) (e.g., wherein X is O) are taken together to form an —O—. In further or alternative specific instances, two R³ groups are optionally taken together (e.g., wherein X is NR₃), such as wherein two R³ groups, such as adjacent R³ groups, are optionally taken together to form a silyl (e.g., —SiR¹R²—) group (in some instances forming a ring).

In some embodiments, the silicon precursor component or silicon precursor comprising is a polysilazane comprising a structure of general formula (Ib):

—[SiR¹R²—NR³]ₙ— (Ib)

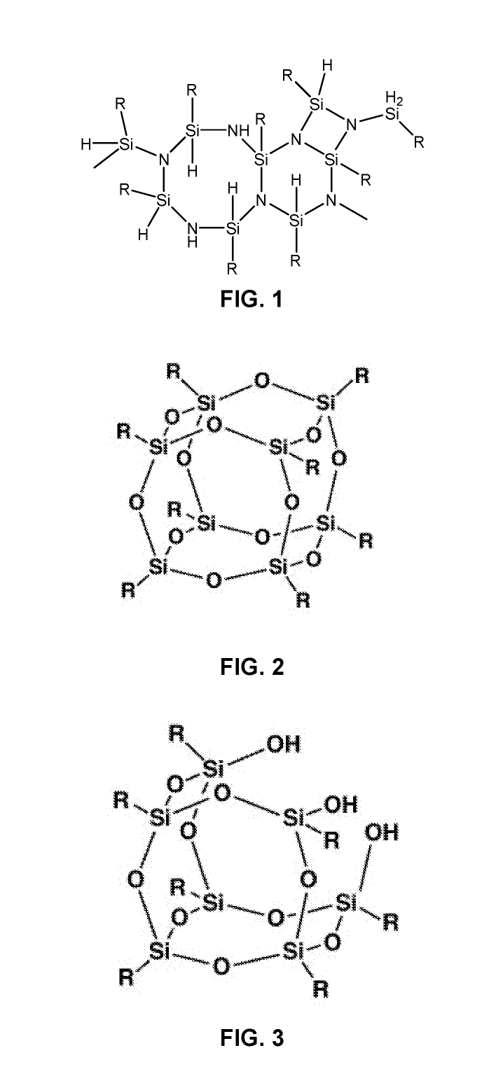

In some instances, the polysilazane has a chain, cyclic, crosslinked structure, or a mixture thereof. FIG. 1 illustrates an exemplary silazane structure having a plurality of units of Ib with cyclic and chain structures. In various embodiments, the polysilzane comprises any suitable number of units, such as 2 to 10,000 units and/or n is any suitable value, such as an integer between 2 and 10,000. In certain embodiments, the polysilazane of formula Ib has an n value such that the 100 to 100,000, and preferably from 300 to 10,000. Additional units are optionally present where each R¹ or R² is optionally cross-linked to another unit of the general formula (I) at the N group—e.g., forming, together with the R³ of another unit a bond—such cross-links optionally form links between separate linear chains, or form cyclic structures, or a mixture thereof. In certain embodiments, the silicon precursor is perhydropolysilazane, such as wherein each R¹, R², and R³ is either H or absent, such as forming a cross-linked structure. In other embodiments, the silicon precursor is an organopolysilazane, wherein the polysilazane comprises one or more structure of formula Ib, wherein R¹, R², or R³ is an organic group, such as a substituted or unsubstituted alkyl or alkoxy, or other organic group described herein. In an exemplary embodiment, a compound of formula Ib comprises a plurality of units having a first structure, e.g., —[SiH₂—NCH₃]—, —[SiHCH₃—NH] and/or —[SiHCH₃—NCH₃]—, and a plurality of units having a second structure, e.g., —[SiH₂NH]—. In specific embodiments, the ratio of the first structure to the second structure is 1:99 to 99:1. Further, in certain embodiments, the compound of formula Ib optionally comprises a plurality of units having a third structure, such as wherein the ratio of the first structure to the third structure is 1:99 to 99:1. The various first, second, and optional third structures may be ordered in blocks, in some other ordered sequence, or randomly. In specific embodiments, each R¹, R², and R³ is independently selected from H and substituted or unsubstituted alkyl (straight chain, branched, cyclic or a combination thereof; saturated or unsaturated). Silicon precursor components and/or silicon materials provided herein resulting from cured polysilazanes described herein (e.g., with addition of water and loss of ammonia and hydrogen) include compounds having Si—N—, Si—O—, and —Si—O—Si— networked structures (e.g., Si ceramics with such a network). In further embodiments, “SiCN” ceramic structures are also included in the network (e.g., wherein curing is conducted at elevated temperature). In various embodiments, following curing, silicon material included in the silicon-carbon composites herein is at least partially reduced, such as providing SiOx, SiOₐN_{b}C_{c} (e.g., comprising Si—N—, Si—O—, —Si—O—Si—, and other networked structures), and/or elemental silicon (e.g., with amorphous and/or crystalline domains).

In some embodiments, the silicon precursor component or silicon precursor comprises a structure of general formula (Ic):

—[SiR¹R²—O]ₙ— (Ic)

In some instances, the compound is a silsesquioxane having a cage (e.g., polyhedral oligomeric) or opened cage (e.g., wherein an SiR¹ is removed from the cage) structure. FIG. 2 illustrates an exemplary cage wherein n is 8 (wherein the R group of FIG. 2 is defined by R¹ herein). FIG. 3 illustrates an exemplary opened cage wherein n is 7 (wherein the R group of FIG. 3 is defined by R¹ herein). In some instances, an R¹ or R² group of one unit is taken together with an R¹ or R² group of another unit to form an —O—. In certain embodiments, a cage structure is optionally formed when several an R¹ or R² groups are taken together with the R¹ or R² groups of other units (e.g., as illustrated in FIG. 2). In various embodiments, the polysilazane comprises any suitable number of units, such as 2 to 20 units and/or n is any suitable value, such as an integer between 2 and 20, e.g., 7-16. In certain embodiments, the cage comprises 8 units, but larger cages are optional. In additional, opened cages, wherein one of the units is absent are also optional.

In further or alternative embodiments, the silicon precursor component or silicon precursor has the following structure (e.g., wherein X is a bond and the unit does not repeat):

R⁴—[SiR¹R²]—R⁵ (Id)

In some embodiments, R⁴ and R⁵ are independently a hydrogen, a halide, OR⁴, SR⁴, NR⁴₂, OSiR⁴₃, or a substituted or unsubstituted hydrocarbon.

Exemplary silicon precursor components or silicon precursors include, by way of non-limiting example, tetraallylsilane, silicon tetrabromide (also referred to herein as silicon bromide), tetra-n-butylsilane, 1,1,3,3-tetrachloro-1,3-disilabutane, tetrachlorosilane (also referred to herein as silicon chloride), tetraethylsilane, tetrakis(dimethylamino)silane, tetrakis(2-trichlorosilylethyl)silane, tetrakis(trimethylsilyl)allene, tetrakis(trimethylsilyl)silane, 2,2,5,5-tetramethyl-2,5-disila-1-azacyclopentane, 1,1,4,4-tetramethyl-1,4-disilabutane, 1,1,3,3-tetramethyldisilazane, triallylmethylsilane, tetraethyl orthosilicate (TEOS), silicon acetate and combinations thereof.

In some embodiments, a polymer in a process, fluid stock or precursor nanomaterial described herein is an organic polymer. In some embodiments, polymer is a hydrophilic polymers, including water-soluble and water swellable polymers (e.g., wherein the fluid medium used in water). Exemplary polymers suitable for the present methods include but are not limited to polyvinyl alcohol (“PVA”), polyvinyl acetate (“PVAc”), polyethylene oxide (“PEO”), polyvinyl ether (“PVE”), polyvinyl pyrrolidone (“PVP”), polyglycolic acid, hydroxyethylcellulose (“HEC”), ethylcellulose, cellulose ethers, polyacrylic acid, polyisocyanate, and the like. In some embodiments, the polymer is isolated from biological material. In some embodiments, the polymer is starch, chitosan, xanthan, agar, guar gum, and the like. In certain instances, a polymer used herein is soluble in an organic solvent, such as dimethylformamide (DMF). In certain embodiments, the polymer utilized herein is polyacrylonitrile (“PAN”), a polyacrylate (e.g., polyalkacrylate, polyacrylic acid, polyalkylalkacrylate, or the like), or a combination thereof. In certain embodiments, a combination of polymers is utilized. In specific embodiments, the polymer is polyacrylonitrile (PAN), polyvinyl ether (PVE), polyethylene oxide (PEO), polyvinyl alcohol (PVA), polyvinylpyrrolidone (PVP), poly acrylic acid (PAA), or a combination thereof.

Other polymer optionally include polyamide resins, aramid resins, polyalkylene oxides, polyolefins, polyethylenes, polypropylenes, polyethyleneterephthalates, polyurethanes, rosin ester resins, acrylic resins, polyacrylate resins, polyacrylamides, polyvinyl alcohols, polyvinyl acetates, polyvinyl ethers, polyvinylpyrollidones, polyvinylpyridines, polyisoprenes, polylactic acids, polyvinyl butyral resins, polyesters, phenolic resins, polyimides, vinyl resins, ethylene vinyl acetate resins, polystyrene/acrylates, cellulose ethers, hydroxyethyl cellulose, ethyl cellulose, cellulose nitrate resins, polymaleic anhydrides, acetal polymers, polystyrene/butadienes, polystyrene/methacrylates, aldehyde resins, cellulosic polymers, polyketone resins, polyfluorinated resins, polyvinylidene fluoride resins, polyvinyl chlorides, polybenzimidazoles, poly vinyl acetates, polyethylene imides, polyethylene succinates, polyethylene sulphides, polyisocyanates, SBS copolymers, polylactic acid, polyglycolic acid, polypeptides, proteins, epoxy resins, polycarbonate resins, coal-tar pitch petroleum pitch and combinations thereof.

Polymers of any suitable molecular weight may be utilized in the processes and nanofibers described herein. In some instances, a suitable polymer molecular weight is a molecular weight that is suitable for electrospinning the polymer as a melt or solution (e.g., aqueous solution or solvent solution—such as in dimethyl formamide (DMF) or alcohol). In some embodiments, the polymer utilized has an average atomic mass of 1 kDa to 1,000 kDa. In specific embodiments, the polymer utilized has an average atomic mass of 10 kDa to 500 kDa. In more specific embodiments, the polymer utilized has an average atomic mass of 10 kDa to 250 kDa. In still more specific embodiments, the polymer utilized has an average atomic mass of 50 kDa to 200 kDa. In certain embodiments, the polymer is combined with (e.g., dissolved in) the liquid medium in any suitable concentration, such as in a wt/wt concentration of 1-70% relative to the liquid medium. In more specific embodiments, the polymer is combined in a wt/wt concentration of 2-30% relative to the liquid medium (e.g., 5-15%), relative to the liquid medium.

In certain embodiments, the polymer and silicon precursor component/precursor are combined or are present in the fluid stock in any suitable amount. In certain embodiments, the amount of polymer is sufficient to provide a nanofiber structure upon electrospinning and the silicon precursor is highly loaded so as to provide high loading of silicon in the silicon-carbon composite following thermo-reduction of the silicon precursor component/precursor (or, at least a portion thereof) to silicon (e.g., amorphous silicon). In certain embodiments, the weight ratio of polymer to silicon precursor component/precursor is less than 20:1. More preferably, the weight ratio of polymer to silicon precursor component/precursor is less than 10:1, such as 2:3 to 10:1. In preferred embodiments, the ratio of polymer to silicon precursor component/precursor is 5:4 to 5:1.

In certain embodiments, a fluid composition is electrospun to provide a nanomaterial (e.g., nanofiber). Generally, this nanomaterial (e.g., nanofiber) comprises a polymer (e.g., a polymer matrix of a nanofiber) and a silicon precursor component. In some instances, the silicon precursor component is the silicon precursor, or a silicon ceramic, e.g., derived from the silicon precursor. For example, in some embodiments, if the fluid composition is prepared with a ceramic precursor (e.g., a sol gel ceramic precursor), the silicon precursor component in the polymer composite nanomaterial may be a silicon ceramic. In specific instances, when TEOS is utilized, the polymer composite nanomaterial may comprise a polymer and a cured or partially cured silicon dioxide ceramic (e.g., via the reaction: Si(OC₂H₅)₄+2 H₂O→SiO₂+4 C₂H₅OH). In further specific instances, e.g., wherein polysilazanes are utilized, the polymer composite nanomaterial may comprise polymer and a cured or partially cured silicon containing ceramic (e.g., a silicon oxide, a siloxane, or a SiCN ceramic, or a ceramic composition comprising a mixture thereof). In certain instances, a fluid stock is optionally prepared by combining a silicon precursor, a polymer and a fluid medium, whereupon the silicon precursor may be converted to a distinct silicon precursor component (e.g., a sol gel of the silicon precursor). Further, in some embodiments, following electrospinning, the silicon precursor component of the fluid stock may further be converted to a second silicon precursor component (e.g., a silicon ceramic of a cured sol gel) before ultimately being thermally reduced to silicon (e.g., wherein the second silicon precursor component is at least partially reduced to silicon, such as amorphous silicon).

In some instances, the silicon precursor component forms, in combination with the polymer, a matrix of a nanofiber. In further or alternative embodiments, the silicon precursor component forms domains within a polymer nanofiber matrix. In specific instances, the domains have an average dimension (e.g., diameter) of less than 100 nm, e.g., less than 50 nm, less than 25 nm, less than 20 nm, or the like.

In certain embodiments, the fluid composition or polymer composite (precursor) nanomaterial further comprises nanostructures comprising silicon (e.g., silicon nanoparticles), and/or a process provided herein comprises combining nanostructures comprising silicon into the fluid composition (e.g., to be electrospun). In specific embodiments, processes provided herein optionally comprise combining (i) a polymer, (ii) a silicon precursor, (iii) a liquid medium, and (iv) nanostructures comprising silicon (e.g., silicon nanoparticles) or other silicon material (e.g., active electrode material). In some instances, silicon nanoparticles are included to increase the silicon content of the silicon-carbon composite nanomaterials provided herein. Generally, small silicon particles are difficult to manufacture or, once manufactured, are difficult to keep from agglomerating to form larger particles. As such, in some instances, silicon nanostructured utilized herein are generally larger than the silicon (e.g., amorphous silicon) domains prepared by reduction of the silicon precursor (or silicon precursor component resulting in situ from the silicon precursor). In certain embodiments, the silicon nanoparticles have an average dimension (e.g., diameter) of at least 20 nm, such as 20 nm to 500 nm, more generally 50 nm to 250 nm. In certain embodiments, the weight ratio of polymer to nanostructured silicon is less than 20:1. More preferably, the weight ratio of polymer to nanostructured silicon is less than 10:1, such as 2:3 to 10:1. In preferred embodiments, the ratio of polymer to nanostructured silicon is 5:4 to 5:1. In some embodiments, the ratio of silicon precursor/component to nanostructured silicon is any suitable amount, such as at least 1:4, at least 1:2, or, preferably, at least 1:1.

In certain embodiments, the fluid composition or polymer composite (precursor) nanomaterial further comprises conducting nanostructures (e.g., carbon nanoinclusions), and/or a process provided herein comprises combining conducting nanostructures into the fluid composition (e.g., to be electrospun). Similarly, processes provided herein optionally comprise combining (i) a polymer, (ii) a silicon precursor, (iii) a liquid medium, (iv) nanostructures comprising silicon, and (v) conducting nanostructures. In some instances, conducting nanostructures are included to increase the electron and electrical conductivity along the between the ultimate silicon-carbon composite nanomaterials provided herein. In specific embodiments, the conducting nanostructures are carbon nanostructures, e.g., carbon nanotubes (CNTs), graphene nanoribbons (GNRs), graphene sheets, or a combination thereof. In further or alternative embodiments, conducting nanostructures comprise a conducting metal or metal oxide (e.g., TiO₂ or Al₂O₃). Any suitable amount of conductive material is optionally utilized. In specific embodiments, the weight ratio of the polymer to the conducting nanostructures is 10:1 to 1000:1.

The fluid medium utilized herein is any solvent suitable for electrospinning. In some embodiments, the solvent is volatile enough to be evaporated during room temperature electrospinning. In various embodiments, exemplary fluid mediums include, by way of non-limiting example, water, C₁-C₆ alcohols including methanol, ethanol, 1-propanol, 2-propanol and the butanols; C₄-C₈ ethers, including diethyl ether, dipropyl ether, dibutyl ether tetrahydropyran and tetrahydrofuran (THF); C₃-C₆ ketones, including acetone, methyl ethyl ketone and cyclohexanone; C₃-C₆ esters including methyl acetate, ethyl acetate, ethyl lactate and n-butyl acetate; and mixtures thereof. Other suitable solvents include halogenated hydrocarbons such as methylene chloride, chloroform, carbon tetrachloride, bromoform, ethylene chloride, ethylidene chloride, trichloroethane and tetrachloroethane; hydrocarbons such as pentane, hexane, isohexane, methylpentane, heptane, isoheptane, octane, decalin, isooctane, cyclopentane, methylcyclopentane, cyclohexane, methylcyclohexane, benzene, toluene, xylene and ethylbenzene. Mixtures of solvents may also be used. Additionally, colloids, dispersions, sol-gels and other non-solutions may be used. In specific embodiments, the liquid medium is dimethyl formamide (DMF), water, dimethylacetamide (DMAC), chloroform, alcohol, or a combination thereof.

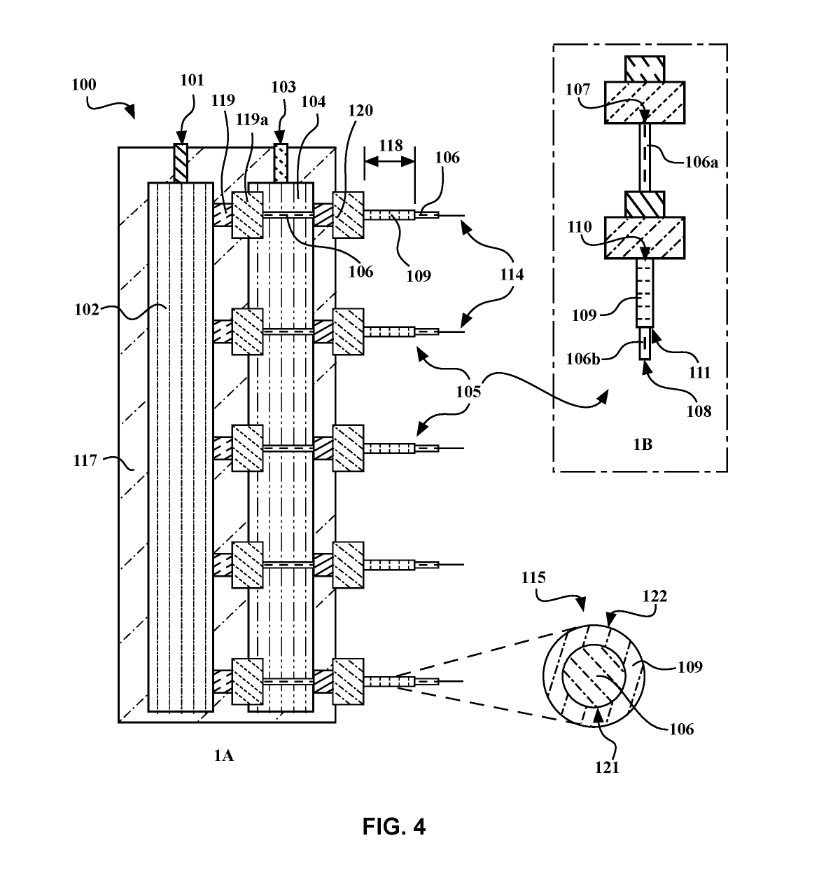

In some embodiments, gas assisted electrospinning is utilized (e.g., about a common axis with the jet electrospun from a fluid stock described herein). Exemplary methods of gas-assisted electrospinning are described in PCT Patent Application PCT/US14/25699 (“Electrospinning Apparatuses & Processes”), which is incorporated herein for such disclosure. In gas-assisted embodiments, the gas is optionally air or any other suitable gas (such as an inert gas, oxidizing gas, or reducing gas). In some embodiments, gas assistance increases the throughput of the process and/or reduces the diameter of the nanofibers. In some instances, gas assisted electrospinning accelerates and elongates the jet of fluid stock emanating from the electrospinner. In some instances, gas assisted electrospinning disperses silicon material in composite nanofibers. For example, in some instances, gas assisted electrospinning (e.g., coaxial electrospinning of a gas—along a substantially common axis—with a fluid stock comprising a silicon precursor component and optional silicon nanoparticles) facilitates dispersion or non-aggregation of the silicon precursor component (and optional silicon nanoparticles) in the electrospun jet and the resulting as-spun nanofiber (and subsequent nanofibers produced therefrom). In some embodiments, the fluid stock is electrospun using any suitable technique, such as providing the fluid stock and voltage to a nozzle. In specific embodiments the nozzle has a coaxial structure wherein the fluid stock and voltage is supplied to an inner conduit of the nozzle and air is supplied to an outer conduit of the nozzle (e.g., an exemplary nozzle system being illustrated in FIG. 4, which is described in more detail in PCT Patent Application PCT/US14/25699, which is incorporated herein for such disclosure). In some embodiments, the fluid composition has any suitable viscosity, such as about 10 mPa·s to about 10,000 mPa·s (at 1/s, 20° C.), or about 100 mPa·s to about 5000 mPa·s (at 1/s, 20° C.), or about 1500 mPa·s (at 1/s, 20° C.). In certain embodiments, fluid stock is provided to the nozzle at any suitable flow rate. In specific embodiments, the flow rate is about 0.01 to about 0.5 mL/min. In more specific embodiments, the flow rate is about 0.05 to about 0.25 mL/min. In still more specific embodiments, the flow rate is about 0.075 mL/min to about 0.125 mL/min, e.g., about 0.1 mL/min. In certain embodiments, the nozzle velocity of the gas is any suitable velocity, e.g., about 0.1 m/s or more. In specific embodiments, the nozzle velocity of the gas is about 1 m/s to about 300 m/s. In certain embodiments, the pressure of the gas provided (e.g., to the manifold inlet or the nozzle) is any suitable pressure, such as about 2 psi to 50 psi, e.g., about 30 psi to 40 psi or about 2 psi to 20 psi. In specific embodiments, the pressure is about 5 psi to about 15 psi. In more specific embodiments, the pressure is about 8 to about 12 psi, e.g., about 10 psi.

In some embodiments, following electrospinning of the precursor nanomaterial (e.g., comprising polymer and a silicon precursor component, such as nanodomains of a silicon precursor component (e.g., a silicon ceramic) embedded within a polymer nanofiber matrix), the precursor nanomaterial is thermally treated. In some instances, thermal treatment of the nanomaterial is performed under non-oxidative conditions (e.g., under inert or reducing conditions). In certain embodiments, thermal treatment of the nanomaterial under non-oxidative conditions carbonizes (at least partially) the polymer component of the precursor nanomaterial. In some embodiments, thermal treatment of the nanomaterial under non-oxidative conditions reduces the silicon precursor component (e.g., a silicon precursor comprising a unit of formula I), a silicon sol gel (e.g., of a silicon precursor of formula I, such as Ib), or a silicon ceramic (e.g., of a cured sol gel of a silicon precursor of formula I, such as Ib) to silicon (e.g., amorphous silicon).

In some embodiments, the precursor nanomaterial is heated to a temperature suitable for carbonizing the polymer thereof. In certain embodiments, the precursor nanomaterial is heated to at least 500 C. In more specific embodiments, the precursor nanomaterial is heated to a temperature of at least 800 C. In still more specific embodiments, the precursor nanomaterial is heated to a temperature of 800 C to 1400 C. In yet more specific embodiments, the precursor nanomaterial is heated to a temperature of 1100 C to 1400 C. In certain embodiments, such thermal treatments are conducted under non-oxidative conditions, such as under inert or reducing conditions. In some embodiments, such thermal treatments are conducted under inert conditions, such as under a nitrogen or argon atmosphere. In certain embodiments, such thermal treatments are conducted under reducing conditions, such as under a hydrogen atmosphere, or an atmosphere of hydrogen mixed with an inert gas, such as hydrogen in nitrogen or hydrogen in argon. In specific embodiments, an atmosphere of hydrogen mixed with an inert gas provided herein comprises at least 2 wt. % hydrogen. In more specific embodiments, an atmosphere of hydrogen mixed with an inert gas provided herein comprises at least 5 wt. % hydrogen. In still more specific embodiments, an atmosphere of hydrogen mixed with an inert gas provided herein comprises 5 wt. % to 10 wt. % hydrogen.

In certain embodiments, the thermal treatment process is a multi-step process. In some embodiments, the thermal treatment process comprises: (i) annealing the nanomaterial (e.g., at a temperature below carbonization of the polymer); (ii) carbonizing the nanomaterial—the polymer thereof (e.g., under inert conditions); and (iii) thermoreducing the nanomaterial—the silicon precursor component thereof to silicon, such as amorphous silicon (e.g., under reducing conditions). In other embodiments, the carbonization and thermoreducing step are combined into a single thermoprocessing step (e.g., under inert or reducing conditions). Any suitable carbonizing and thermoreducing temperature is optionally utilized, such as at least 500 C (e.g., at least 800 C, 800 C to 1400 C, 1100 C to 1400 C, or the like). In certain embodiments, the thermal treatment comprises annealing the precursor nanomaterial (e.g., prior to thermal calcination and/or thermoreduction), such as at a temperature of 50 C to 500 C, e.g., 50 C to 200 C, or 80 C to 120 C.

In some instances, the silicon material (e.g., amorphous silicon or SiOx, e.g., which is the thermoreduced silicon precursor component) forms, in combination with the carbon (e.g., carbonized polymer), a matrix of a nanofiber. In further or alternative embodiments, the silicon material forms domains within a carbon nanofiber matrix. In specific instances, the domains have an average dimension (e.g., diameter) of less than 100 nm, e.g., less than 50 nm, less than 25 nm, less than 20 nm, or the like.

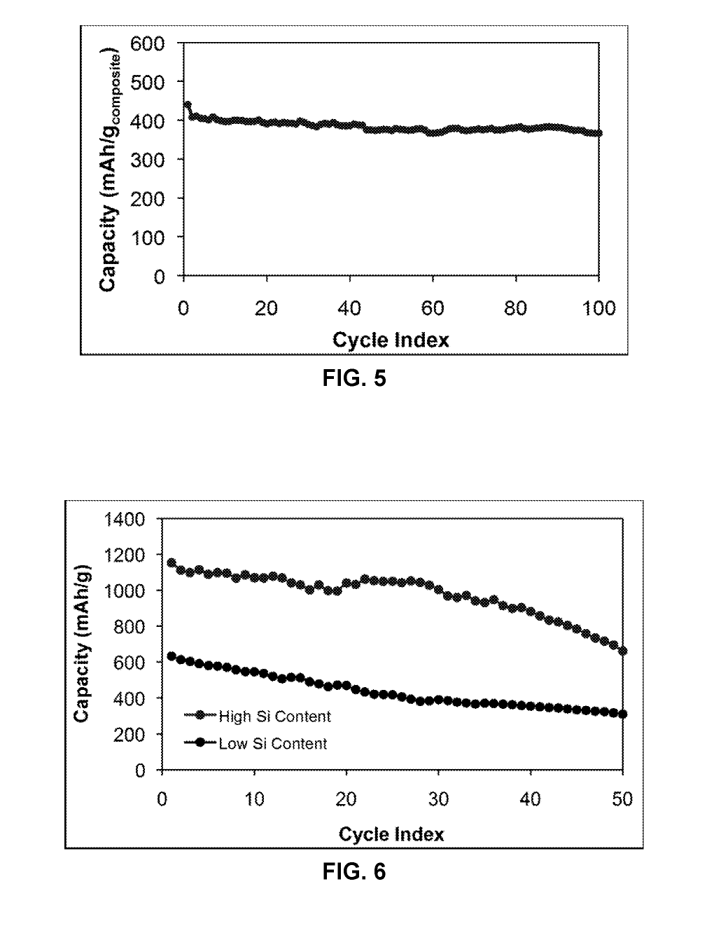

In certain embodiments, provided herein are silicon-carbon nanocomposites, such as nanofibers. In some embodiments, the silicon-carbon nanostructured composites are used as or are useful as battery electrode materials, such as lithium ion battery anode active materials. In certain embodiments, the silicon-carbon nanostructured composites comprise a carbon matrix with nanodomains embedded therein, the nanodomains comprising silicon material (e.g., silicon or SiOx, such as amorphous silicon). FIG. 5 and FIG. 6 illustrate capacities and cycling of anodes comprising exemplary silicon-carbon nanostructured composites provided herein. In certain embodiments, the nanodomains have an average dimension of less than 100 nm, e.g., less than 50 nm, less than 25 nm, less than 20 nm, or the like. In specific embodiments, such nanodomains comprise amorphous silicon material (e.g., SiOx, such as wherein 0<x<2 or x=0). In specific embodiments, the silicon-carbon nanostructured composites comprise a carbon matrix, with a plurality of first domains embedded therein and a plurality of second domains embedded therein. In specific embodiments, the first domains comprise amorphous silicon and the second domains comprise crystalline silicon. In certain embodiments, the first domains have an dimension (e.g., diameter) of less than 100 nm, e.g., less than 50 nm, less than 25 nm, less than 20 nm, or the like. In further or alternative embodiments, the second domains have an average dimension (e.g., diameter) of at least 20 nm, e.g., 20 nm to 500 nm, or 50 nm to 250 nm. In certain embodiments, the silicon-carbon nanostructured composite comprises 15 wt. % carbon to 70 wt. % carbon. In specific embodiments, the silicon-carbon nanostructured composite comprises 20 wt. % carbon to 50 wt. % carbon. In some embodiments, the silicon-carbon nanostructured composite comprises 20 wt. % silicon material to 90 wt. % silicon material. In specific embodiments, the silicon-carbon nanostructured composite comprises 50 wt. % silicon material to 85 wt. % silicon material. In some embodiments, the silicon-carbon nanostructured composite comprises 5 wt. % silicon to 90 wt. % silicon (e.g., on an elemental basis). In specific embodiments, the silicon-carbon nanostructured composite comprises 10 wt. % silicon to 70 wt. % silicon (e.g., on an elemental basis). In some embodiments, the silicon-carbon nanostructured composite comprises 20 wt. % silicon to 90 wt. % silicon. In specific embodiments, the silicon-carbon nanostructured composite comprises 50 wt. % silicon to 85 wt. % silicon. In certain embodiments, the silicon-carbon nanostructured composite comprises 5 wt. % amorphous silicon to 90 wt. % amorphous silicon. In some embodiments, the silicon-carbon nanostructured composite comprises 0 wt. % crystalline silicon to 50 wt. % crystalline silicon, e.g., 10 wt. % crystalline silicon to 30 wt. % crystalline silicon. Further, in some embodiments, the silicon-carbon nanostructured composite comprises conductive domains embedded within the carbon matrix. In certain embodiments, the conductive domains comprise nanostructured metal, metal oxide, or carbon. In specific embodiments, preferred are carbon nanostructures, such as carbon nanotubes, graphene nanoribbons, graphene, graphene oxide, reduced graphene oxide, or the like. In some embodiments, the silicon-carbon nanostructured composite comprises 0 wt. % to 10 wt. % conductive material, e.g., 1 wt. % to 4 wt. % conductive material. In certain embodiments, such silicon-carbon nanostructured composites are prepared according to a processes described herein. And, in some embodiments, provided herein are silicon-carbon nanostructured composites prepared according to any process described herein. Similarly, fluid compositions and nanomaterials are provided for in various embodiments herein.

In some embodiments, provided herein is a battery cell comprising a silicon-carbon nanostructured composite provided herein as well as processes of preparing such cells. In specific embodiments, the battery cell is a lithium ion battery cell. In more specific embodiments, the lithium ion battery comprises an anode, a cathode and a separator, the anode comprising (e.g., as an anode active material) a silicon-carbon nanostructured composite provided herein. In certain embodiments, provided herein is an electrode (e.g., a lithium ion battery anode) comprising a silicon-carbon nanostructured composite provided herein (e.g., as an active material thereof). In some embodiments, provided herein is a process of manufacturing an electrode comprising combining a silicon-carbon composite provided herein with a binder and an optional conductive material (e.g., a carbon material, such as carbon black). In certain embodiments, a process provided herein comprises depositing a silicon-carbon nanostructured composite provided herein (e.g., after combining with a binder and optional conductive material) on a current collector (e.g., a metal—such as copper or aluminum—foil). In certain embodiments, provided herein is a process for assembling a lithium ion battery, the process comprising preparing an anode according to the process described herein and combining the anode with a separator and a cathode (e.g., a cathode comprising a lithium metal oxide, such as represented by the formula Liₐ(NiₓMn_{y}Co_{z})_{b}O, wherein a is 0.9 to 1.2, e.g., about 1, b is 0.9 to 1.2, e.g., about 1, 0≤x<1, 0≤y<1, 0<x≤1, x+y+z is 1).

### EXAMPLES

### Example 1—Fluid Electrospinning Stock

Electrospinning fluid stocks are prepared by combining a silicon precursor, a polymer and a solvent. Precursor and polymer are combined in various solvents, with preferred samples having good polymer and precursor solubility, miscibility, and/or dispersion in the solvent. Exemplary combinations are illustrated in Table 1.

TABLE 1

| | | | Polymer |
|---|---|---|---|
| | Precursor:Polymer | | concentration |
| Polymer | (wt/wt) | Solvent | (wt./wt.) |
| PAN | 0.8:1 | DMF | 5% |
| PEO | 0.5:1 | THF/EtOH | 10% |
| PAN | 0.2:1 | DMF | 20% |
| PEO | 0.4:1 | THF/EtOH | 10% |
| PAN | 0.1:1 | DMAC | 20% |
| PAN | 1:1 | DMF | 5% |
| PEO | 0.5:1 | THF/EtOH | 10% |
| PAN | 0.3:1 | DMF | 30% |
| PAN | 1.2:1 | DMF | 3% |
| PAN | 0.5:1 | DMF | 8% |
| PAN | 0.15:1 | DMF | 20% |
| PAN | 0.8:1 | DMF | 5% |
| PEO | 0.4:1 | THF/EtOH | 10% |
| PAN | 0.1:1 | DMF | 20% |
| PAN | 0.9:1 | DMF | 5% |

Samples are prepared using tetraallylsilane, silicon tetrabromide (also referred to herein as silicon bromide), tetra-n-butylsilane, 1,1,3,3-tetrachloro-1,3-disilabutane, tetrachlorosilane (also referred to herein as silicon chloride), tetraethylsilane, tetrakis(dimethylamino)silane, tetrakis(2-trichlorosilylethyl)silane, tetrakis(trimethylsilyl)allene, tetrakis(trimethylsilyl)silane, 2,2,5,5-tetramethyl-2,5-disila-1-azacyclopentane, 1,1,4,4-tetramethyl-1,4-disilabutane, 1,1,3,3-tetramethyldisilazane, triallylmethylsilane, tetraethyl orthosilicate (TEOS), silicon acetate, as well as a variety of silsesquioxanes, including, e.g., compounds of FIG. 2 wherein each R is epoxycyclohexyl and wherein each R is PEG (—CH₂CH₂—(OCH₂CH₂)ₘOCH₃, wherein m is, on average, about 13.3) and compounds of FIG. 3 wherein each R is isobutyl, perhydropolysilazane (e.g., NN (e.g., NN120), NL (e.g., NL120A), or NAX (e.g., NAX120) series from AZ® Electronic Materials, Somerville, N.J., USA), or organopolysilazane (e.g., Durazane 1500 (RC and SC) or 1800 series, from AZ® Electronic Materials, Somerville, N.J., USA).

Upon combination, the mixture is stirred (e.g., at room temperature) until substantially uniform (e.g., about 60 minutes).

### Example 2—Electrospinning

Electrospinning fluid stocks are prepared according to Example 1. The prepared stock is pumped into the inner channel of a nozzle having an inner channel and an outer channel around the inner channel, and pressured air is provided to the outer channel of the nozzle. The fluid stock is provided to the nozzle at a rate of about 0.1 mL/min (or about 0.075 mL/min to about 0.12 mL/min) and the compressed air is provided at a pressure of about 10 psi (or about 8 psi to about 12 psi). The distance between the nozzle and collection plate is about 20-30 cm (e.g., about 25 cm), and a charge of about +25 kV (or about +20 to about +30 kV) is maintained at the needle.

Nanostructured materials are collected on the grounded collection plate and are removed for further processing.

### Example 3—Annealing

Nanostructured materials comprising polymers having a polymer matrix and silicon precursor component are prepared according to Example 2 and subsequently thermally annealed under air at a variety of temperatures, such as 50 C, 80 C, 100 C, and 120 C.

### Example 4—Thermal Treatment: Inert Atmosphere

Nanostructured materials comprising polymers having a polymer matrix and silicon precursor component are prepared according to Example 2 or Example 3 and subsequently thermally treated under non-oxidative conditions to provide a carbon-silicon nanostructured composite material. Generally, the nanostructured precursor materials are thermally treated at a temperature of about 600 C, 800 C, 1000 C, or 1200 C under an inert atmosphere comprising nitrogen and/or argon.

### Example 5—Thermal Treatment: Reducing Atmosphere

Nanostructured materials comprising polymers having a polymer matrix and silicon precursor component are prepared according to Example 2 or Example 3 and subsequently thermally treated under non-oxidative conditions to provide a carbon-silicon nanostructured composite material. Generally, the nanostructured precursor materials are thermally treated at a temperature of about 600 C, 800 C, 1000 C, or 1200 C under a reducing atmosphere comprising 5% hydrogen in argon, 10% hydrogen in argon, or 100% hydrogen.

### Example 5a

Additionally, certain carbon-silicon nanostructured composite materials of Example 4 are further thermally treated under reducing conditions. Generally, this further thermal treatment is performed at a temperature of about 600 C, 800 C, 1000 C, or 1200 C under a reducing atmosphere comprising 5% hydrogen in argon, 10% hydrogen in argon, or 100% hydrogen.

### Example 6—Lithium Ion Battery Cells

Following reduction according to Example 4 or Example 5, a lithium ion battery half cell is prepared. Coin cell-typed Li-ion batteries are fabricated by using various Si—C nanofibers. The C—Si nanofibers are blended with Super P (Timcal) and poly(acrylic acid) (PAA, Mw=3,000,000) for 70:15:15 wt % in 1-Methyl-2-pyrrolidinone (NMP, Aldrich) in order to make a homogeneous slurry. After the slurries are dropped on a current collector with 9 μm thickness (Cu foil, MTI), the working electrodes using C—Si nanofibers are dried in the vacuum oven at 80° C. to remove the NMP solvent.

For fabricating the half cells, Li metal is used as a counter electrode and polyethylene (ca. 25 μm thickness) was inserted as a seperator between working electrode and counter electrode. The mass of working electrode is 3-4 mg/cm². The coin cell-typed Li-ion batteries are assembled in Ar-filled glove box with electrolyte.

The cut off voltage during the galvanostatic tests is 0.01˜2.0 V for anode and 2.5˜4.2 V by using battery charge/discharge cyclers from MTI. Full cells are prepared in a similar manner, and are composed of C—Si nanofibers as anode and stock-LiCoO₂ as cathode. The cut off voltage during the galvanostatic tests is 2.5˜4.5 V. The impedance measurements for all battery cells were performed from 1 Hz to 10 kHz frequency under potentiostatic mode at open circuit voltages of the cells.

FIG. 5 shows a cycle index for an illustrative Si—C composite prepared according to Example 5. As can be seen, activity of anode indicates conversion of the silicon precursor component to silicon and capacities of about 400 mAh/g_{composite} are obtained, with good cycling up to 100 cycles.

### Example 7—Si Inclusions

A fluid stock is prepared similar to Example 1, with the exception that Si nanoparticles are also combined into the fluid stock (e.g., in a silicon nanoparticle to polymer weight ratio of 0.2:1 to 0.8:1). Precursor nanofibers are prepared according to Example 2, and Si—C composites are prepared according to Examples 4 and 5. Lithium ion battery half and full cells are prepared according to Example 6.

### Example 8—Si & C Inclusions

A fluid stock is prepared similar to Example 1, with the exception that Si nanoparticles and CNTs are also combined into the fluid stock (e.g., in a silicon nanoparticle to polymer weight ratio of 0.2:1 to 0.8:1, and 1-4 wt % CNT). Precursor nanofibers are prepared according to Example 2, and Si—C composites are prepared according to Examples 4 and 5. Lithium ion battery half and full cells are prepared according to Example 6.

FIG. 6 shows a cycle index for an illustrative Si—C composite prepared accordingly. As can be seen, capacities of about 400-1200 mAh/g_{composite} are obtained.

### Example 8a

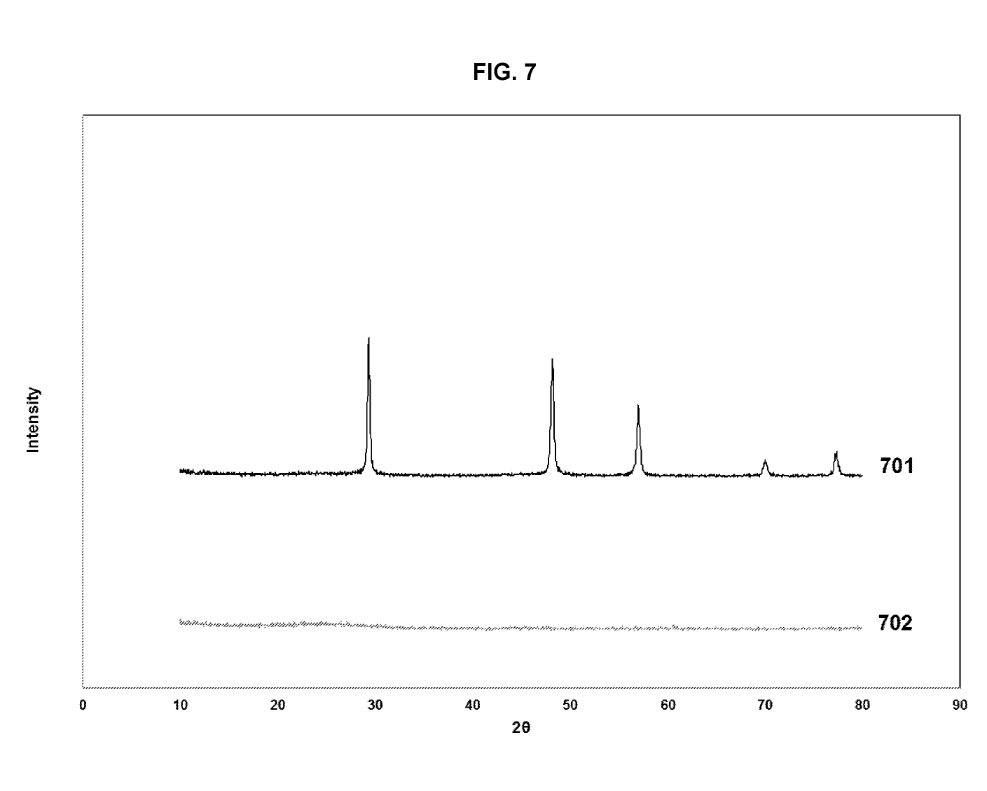

For comparison purposes, a fluid stock is prepared similar to Example 8, with the exception that silicon precursor is not included. An X-Ray diffraction (XRD) analysis of the resultant Si—C composite demonstrates inclusion of crystalline silicon, as illustrated in FIG. 7, 701. Conversely, an XRD analysis FIG. 7, 702 of a Si—C composite of Example 5a did not display the characteristics of any crystalline silicon (though cycling data demonstrated the presence of silicon, indicating the presence of amorphous silicon).

1. A process for preparing a lithium battery negative electrode active material comprising a nanostructured silicon-carbon composite, the process comprising:
a. combining (i) a polymer, (ii) a silicon precursor, and (iii) a liquid medium to form a fluid composition;
b. electrospinning the fluid composition to form a nanostructured polymer composite; and
c. thermally treating the nanostructured polymer composite,
whereby the process provides a nanostructured silicon-carbon composite, the nanostructured silicon-carbon composite comprising carbon and a lithium battery negative electrode active silicon material.

2. The process of claim 1, wherein the polymer is polyacrylonitrile (PAN), polyvinyl ether (PVE), polyethylene oxide (PEO), polyvinyl alcohol (PVA), polyvinylpyrrolidone (PVP), poly acrylic acid (PAA).

3. The process of claim 1, wherein the silicon precursor is an organosilicon, a silicon halide, a sol gel precursor of a silicon ceramic, a siloxane, a silsesquioxane, a silazane, an organo silicate, or a combination thereof.

4. The process of claim 3, wherein the silicon precursor is represented by the following formula:
R⁴—[SiR¹R²]—R⁵
wherein R¹, R², R⁴ and R⁵ are independently a hydrogen, a halide, OR^{4′}, SR^{4′}, NR^{4′}₂, OSiR^{4′}₃, and each R^{4′} is independently hydrogen or a hydrocarbon.

5. The process of claim 4, wherein the silicon precursor is tetraethyl orthosilicate (TEOS).

6. The process of claim 1, wherein the weight ratio of polymer to silicon precursor is 2:3 to 10:1.

7. (canceled)

8. (canceled)

9. (canceled)

10. The process of claim 1, wherein formation of the fluid composition comprises combining (i) a polymer, (ii) a silicon precursor, (iii) a liquid medium, (iv) nanostructures comprising silicon, and (v) conducting nano structures.

11. (canceled)

12. (canceled)

13. (canceled)

14. The process of claim 10, wherein the weight ratio of the polymer to the conducting nanostructures is 1000:1 to 10:1.

15. The process of claim 1, wherein the liquid medium is dimethyl formamide (DMF), water, dimethylacetamide (DMAC), chloroform, alcohol, tetrahydrofuran (THF), or a combination thereof.

16. The process of claim 1, wherein the electrospinning is gas-assisted electro spinning.

17. The process of claim 1, wherein thermal treatment of the nano structured composite comprises heating to at least 500 C.

18. The process of claim 1, wherein thermal treatment of the nano structured polymer is performed under an atmosphere comprising hydrogen.

19. The process of claim 18, wherein the atmosphere comprises at least 2% hydrogen.

20. The process of claim 1, wherein the process further comprises annealing the nano structured polymer composite at a temperature of 100 C to 500 C.

21. (canceled)

22. (canceled)

23. (canceled)

24. The process of claim 1, wherein the process further comprises assembling an anode comprising the nanostructured silicon-carbon composite, and assembling a lithium ion battery comprising the anode.

25. The process of claim 1, wherein the polymer is combined in a wt/wt concentration of 2-30%, relative to the liquid medium.

26. (canceled)

27. (canceled)

28. (canceled)

29. (canceled)

30. (canceled)

31. A silicon-carbon composite nanofiber comprising a matrix of carbon and amorphous silicon.

32. (canceled)

33. (canceled)

34. A composite nanofiber comprising a matrix comprising polymer and a substoichiometric silicon oxide.

35. (canceled)
